(19) United States
(12) Patent Application Publication
(10) Pub. No.: US 2015/0312568 A1
(43) Pub. Date: Oct. 29, 2015

(54) METHOD AND TECHNICAL EQUIPMENT FOR VIDEO ENCODING AND DECODING

(71) Applicant: Nokia Technologies Oy, Espoo (FI)

(72) Inventors: Jani LAINEMA, Tampere (FI); Done BUGDAYCI, Tampere (FI); Kemal UGUR, Istanbul (TR)

(21) Appl. No.: 14/659,077

(22) Filed: Mar. 16, 2015

Related U.S. Application Data
(60) Provisional application No. 61/954,129, filed on Mar. 17, 2014.

(51) Int. Cl. H04N 19/112; H04N 19/16; H04N 19/186; H04N 19/182

(52) U.S. Cl. CPC H04N 19/112; H04N 19/182; H04N 19/16; H04N 19/186

(57) ABSTRACT

There are disclosed various methods, apparatuses and computer program products for video encoding/decoding. In some embodiments the method comprises decoding a coding unit being coded with palette coding, wherein an indication of a scan order of the palette mode is decoded for said coding unit. Mode information for at least one pixel within the coding unit is decoded. Depending on the mode information, a decoded pixel value is set based on indicated scan order; or an indication to determine the number of the pixels sharing the value and indication for a reconstruction value of number of pixels are decoded; or an indication for a reconstruction value of a pixel is decoded.

### TECHNICAL FIELD

The present application relates generally to coding and decoding of digital material. In particular, the present application relates to scalable and high fidelity coding.

### BACKGROUND

This section is intended to provide a background or context to the invention that is recited in the claims. The description herein may include concepts that could be pursued, but are not necessarily ones that have been previously conceived or pursued. Therefore, unless otherwise indicated herein, what is described in this section is not prior art to the description and claims in this application and is not admitted to be prior art by inclusion in this section.

A video coding system may comprise an encoder that transforms an input video into a compressed representation suited for storage/transmission and a decoder that can uncompress the compressed video representation back into a viewable form. The encoder may discard some information in the original video sequence in order to represent the video in a more compact form, for example, to enable the storage/transmission of the video information at a lower bitrate than otherwise might be needed.

### SUMMARY

Some embodiments provide a method, an apparatus, a computer program product, a computer-readable medium for encoding and decoding video information.

Various aspects of examples of the invention are provided in the detailed description.

According to a first aspect, there is provided a method comprising decoding a coding unit being coded with palette coding, comprising decoding an indication of a scan order of the palette mode; decoding mode information for at least one pixel within the coding unit, and if said mode information indicates a copy mode, a decoded pixel value is set based on indicated scan order; or if said mode information indicates that more than one pixel shares a certain value, an indication to determine the number of the pixels sharing the value and indication for a reconstruction value of number of pixels are decoded; and corresponding group of pixels is determined by using the scan order of the palette mode and the determined number of pixels, and the values of the pixels in the corresponding group of pixels is set to the reconstructed value; or if said mode information indicates that a palette index is used for one pixel, an indication for a reconstruction value of a pixel is decoded, and corresponding pixel is determined by using the scan order of the palette mode, and the value of the corresponding pixel is set to the reconstructed value.

According to an embodiment, the scan order indicates a horizontal scan from left to right, wherein the method further comprises setting scan order for the coding unit as horizontal raster scan; decoding mode indications for pixels starting from a top-left pixel; if the mode indication is an above copy mode, setting the reconstruction of the pixel as the reconstruction value of the pixel directly above the current pixel; if the mode indication is a run-length mode, signalling a pixel value and an associated run value; if the mode indication is escape mode, signalling the value of the current pixel.

According to an embodiment, the scan order indicates a vertical scan from top to bottom, wherein the method further comprises setting scan order for the coding unit as vertical raster scan; decoding mode indications for pixels starting from a top-left pixel; if the mode indication is left copy mode, setting the reconstruction of the pixel as the reconstruction value of the pixel directly left of the current pixel; if the mode is run-length mode, signalling a pixel value and associated run value; if the mode indication is escape mode, signalling the value of the current pixel.

According to an embodiment, the scan order indicates one of the following scan types: horizontal from right to left, vertical from bottom to up, diagonal or spiral from the center of the block.

According to an embodiment, the scan order indicates more than one scan type within a coding unit, wherein the method comprises signaling scan types at a sub-coding unit level.

According to an embodiment the method comprises coding the scan type indication predictively using information from neighboring coding units.

According to an embodiment, the method comprises decoding an indication for the scan order for said coding unit

According to an embodiment, the method comprises decoding an indication for the scan order for slice header.

According to a second aspect, there is provided an apparatus comprising at least one processor; and at least one memory including computer program code the at least one memory and the computer program code configured to, with the at least one processor, cause the apparatus to perform at least the following: decoding a coding unit being coded with palette coding, comprising decoding an indication of a scan order of the palette mode; decoding mode information for at least one pixel within the coding unit, and if said mode information indicates a copy mode, a decoded pixel value is set based on indicated scan order; or if said mode information indicates that more than one pixel shares a certain value, an indication to determine the number of the pixels sharing the value and indication for a reconstruction value of number of pixels are decoded; and corresponding group of pixels is determined by using the scan order of the palette mode and the determined number of pixels, and the values of the pixels in the corresponding group of pixels is set to the reconstructed value; or if said mode information indicates that a palette index is used for one pixel, an indication for a reconstruction value of a pixel is decoded, and corresponding pixel is determined by using the scan order of the palette mode, and the value of the corresponding pixel is set to the reconstructed value.

According to a third aspect, there is provided an apparatus comprising means for processing; means for decoding an indication of a scan order of the palette mode; means for decoding mode information for at least one pixel within the coding unit, and means for determining if said mode information indicates a copy mode, wherein a decoded pixel value is set based on indicated scan order; or if said mode information indicates that more than one pixel shares a certain value, wherein means for decoding is configured to decode an indication to determine the number of the pixels sharing the value and indication for a reconstruction value of number of pixels; and corresponding group of pixels is determined by using the scan order of the palette mode and the determined number of pixels, and the values of the pixels in the corresponding group of pixels is set to the reconstructed value; or if said mode information indicates that a palette index is used for one pixel, wherein the means for decoding is configured to decode an indication for a reconstruction value of a pixel, and corresponding pixel is determined by using the scan order of the palette mode, and the value of the corresponding pixel is set to the reconstructed value.

According to a fourth aspect, there is provided a computer program product comprising a computer-readable medium bearing computer program code embodied therein for use with a computer, the computer program code comprising: code for decoding an indication of a scan order of the palette mode; code for decoding mode information for at least one pixel within the coding unit, and if said mode information indicates a copy mode, a decoded pixel value is set based in indicated scan order; or if said mode information indicates that more than one pixel shares a certain value, an indication to determine the number of the pixels sharing the value and indication for a reconstruction value of number of pixels are decoded; and corresponding group of pixels is determined by using the scan order of the palette mode and the determined number of pixels, and the values of the pixels in the corresponding group of pixels is set to the reconstructed value; or if said mode information indicates that a palette index is used for one pixel, an indication for a reconstruction value of a pixel is decoded, and corresponding pixel is determined by using the scan order of the palette mode, and the value of the corresponding pixel is set to the reconstructed value.

According to a fifth aspect, there is provided a non-transitory computer-readable medium encoded with instructions that, when executed by a computer, perform decoding an indication of a scan order of the palette mode; decoding mode information for at least one pixel within the coding unit, and if said mode information indicates a copy mode, a decoded pixel value is set based on indicated scan order; or if said mode information indicates that more than one pixel shares a certain value, an indication to determine the number of the pixels sharing the value and indication for a reconstruction value of number of pixels are decoded; and corresponding group of pixels is determined by using the scan order of the palette mode and the determined number of pixels, and the values of the pixels in the corresponding group of pixels is set to the reconstructed value; or if said mode information indicates that a palette index is used for one pixel, an indication for a reconstruction value of a pixel is decoded and corresponding pixel is determined by using the scan order of the palette mode, and the value of the corresponding pixel is set to the reconstructed value.

### BRIEF DESCRIPTION OF THE DRAWINGS

For a more complete understanding of example embodiments of the present invention, reference is now made to the following descriptions taken in connection with the accompanying drawings in which:

FIG. 1 illustrates a block diagram of a video coding system according to an embodiment;

FIG. 2 illustrates a layout of an apparatus according to an embodiment;

FIG. 3 illustrates an arrangement for video coding comprising a plurality of apparatuses, networks and network elements according to an example embodiment;

FIG. 4 illustrates a block diagram of a video encoder according to an embodiment;

FIG. 5 illustrates a block diagram of a video decoder according to an embodiment;

FIG. 6 illustrates examples of different scan types;

FIG. 7 illustrates examples of different copy modes; and

FIG. 8 illustrates examples of different scan orders with a palette coded coding unit; and

FIG. 9 illustrates an example of a method as a flowchart.

### DETAILED DESCRIPTION OF SOME EXAMPLE EMBODIMENTS

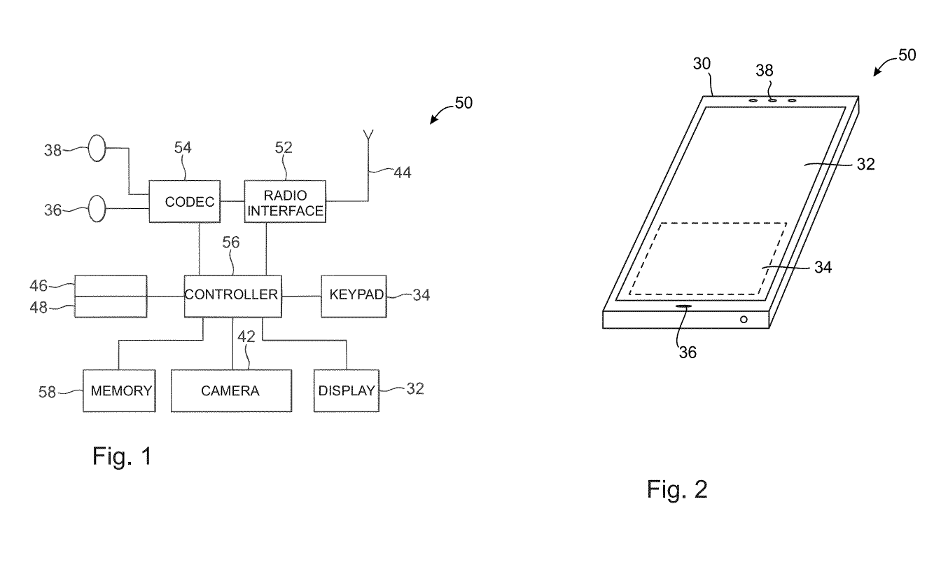

FIG. 1 shows a block diagram of a video coding system according to an example embodiment as a schematic block diagram of an exemplary apparatus or electronic device 50, which may incorporate a codec according to an embodiment of the invention. FIG. 2 shows a layout of an apparatus according to an example embodiment. The elements of FIGS. 1 and 2 will be explained next.

The electronic device 50 may for example be a mobile terminal or user equipment of a wireless communication system. However, it would be appreciated that embodiments of the invention may be implemented within any electronic device or apparatus which may require encoding and decoding or encoding or decoding video images.

The apparatus 50 may comprise a housing 30 for incorporating and protecting the device. The apparatus 50 further may comprise a display 32 in the form of a liquid crystal display. In other embodiments of the invention the display may be any suitable display technology suitable to display an image or video. The apparatus 50 may further comprise a keypad 34. In other embodiments of the invention any suitable data or user interface mechanism may be employed. For example the user interface may be implemented as a virtual keyboard or data entry system as part of a touch-sensitive display. The apparatus may comprise a microphone 36 or any suitable audio input which may be a digital or analogue signal input. The apparatus 50 may further comprise an audio output device which in embodiments of the invention may be any one of: an earpiece 38, speaker, or an analogue audio or digital audio output connection. The apparatus 50 may also comprise a battery 40 (or in other embodiments of the invention the device may be powered by any suitable mobile energy device such as solar cell, fuel cell or clockwork generator). The apparatus may further comprise a camera 42 capable of recording or capturing images and/or video. In some embodiments the apparatus 50 may further comprise an infrared port for short range line of sight communication to other devices. In other embodiments the apparatus 50 may further comprise any suitable short range communication solution such as for example a Bluetooth wireless connection or a USB/firewire wired connection.

The apparatus 50 may comprise a controller 56 or processor for controlling the apparatus 50. The controller 56 may be connected to memory 58 which in embodiments of the invention may store both data in the form of image and audio data and/or may also store instructions for implementation on the controller 56. The controller 56 may further be connected to codec circuitry 54 suitable for carrying out coding and decoding of audio and/or video data or assisting in coding and decoding carried out by the controller 56.

The apparatus 50 may further comprise a card reader 48 and a smart card 46, for example a UICC and UICC reader for providing user information and being suitable for providing authentication information for authentication and authorization of the user at a network.

The apparatus 50 may comprise radio interface circuitry 52 connected to the controller and suitable for generating wireless communication signals for example for communication with a cellular communications network, a wireless communications system or a wireless local area network. The apparatus 50 may further comprise an antenna 44 connected to the radio interface circuitry 52 for transmitting radio frequency signals generated at the radio interface circuitry 52 to other apparatus(es) and for receiving radio frequency signals from other apparatus(es).

In some embodiments of the invention, the apparatus 50 comprises a camera capable of recording or detecting individual frames which are then passed to the codec 54 or controller for processing. In some embodiments of the invention, the apparatus may receive the video image data for processing from another device prior to transmission and/or storage. In some embodiments of the invention, the apparatus 50 may receive either wirelessly or by a wired connection the image for coding/decoding.

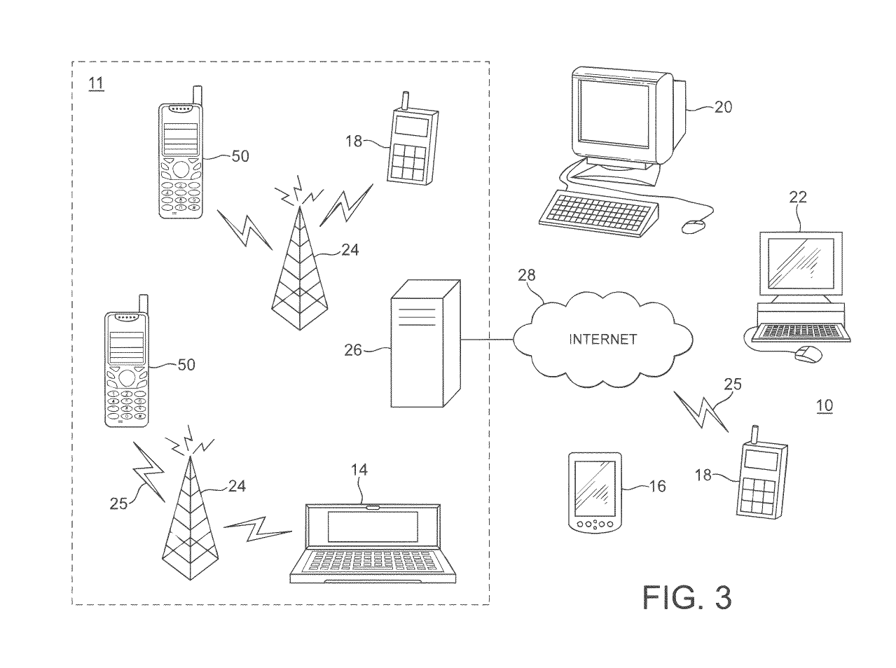

FIG. 3 shows an arrangement for video coding comprising a plurality of apparatuses, networks and network elements according to an example embodiment. With respect to FIG. 3, an example of a system within which embodiments of the present invention can be utilized is shown. The system 10 comprises multiple communication devices which can communicate through one or more networks. The system 10 may comprise any combination of wired or wireless networks including, but not limited to a wireless cellular telephone network (such as a GSM, UMTS, CDMA network etc.), a wireless local area network (WLAN) such as defined by any of the IEEE 802.x standards, a Bluetooth personal area network, an Ethernet local area network, a token ring local area network, a wide area network, and the Internet.

The system 10 may include both wired and wireless communication devices or apparatus 50 suitable for implementing embodiments of the invention. For example, the system shown in FIG. 3 shows a mobile telephone network 11 and a representation of the internet 28. Connectivity to the internet 28 may include, but is not limited to, long range wireless connections, short range wireless connections, and various wired connections including, but not limited to, telephone lines, cable lines, power lines, and similar communication pathways.

The example communication devices shown in the system 10 may include, but are not limited to, an electronic device or apparatus 50, a combination of a personal digital assistant (PDA) and a mobile telephone 14, a PDA 16, an integrated messaging device (IMD) 18, a desktop computer 20, a notebook computer 22. The apparatus 50 may be stationary or mobile when carried by an individual who is moving. The apparatus 50 may also be located in a mode of transport including, but not limited to, a car, a truck, a taxi, a bus, a train, a boat, an airplane, a bicycle, a motorcycle or any similar suitable mode of transport.

Some or further apparatuses may send and receive calls and messages and communicate with service providers through a wireless connection 25 to a base station 24. The base station 24 may be connected to a network server 26 that allows communication between the mobile telephone network 11 and the internet 28. The system may include additional communication devices and communication devices of various types.

The communication devices may communicate using various transmission technologies including, but not limited to, code division multiple access (CDMA), global systems for mobile communications (GSM), universal mobile telecommunications system (UMTS), time divisional multiple access (TDMA), frequency division multiple access (FDMA), transmission control protocol-internet protocol (TCP-IP), short messaging service (SMS), multimedia messaging service (MMS), email, instant messaging service (IMS), Bluetooth, IEEE 802.11 and any similar wireless communication technology. A communications device involved in implementing various embodiments of the present invention may communicate using various media including, but not limited to, radio, infrared, laser, cable connections, and any suitable connection.

Video codec may comprise an encoder that transforms the input video into a compressed representation suited for storage/transmission, and a decoder is able to uncompress the compressed video representation back into a viewable form. The encoder may discard some information in the original video sequence in order to represent the video in more compact form (i.e. at lower bitrate).

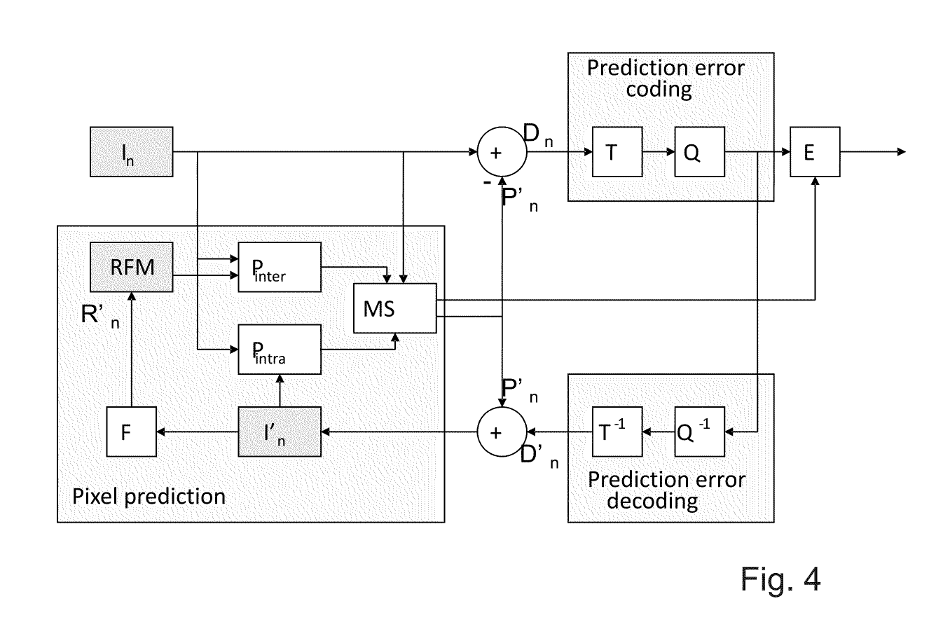

Hybrid video codecs, for example ITU-T H.263 and H.264, encode the video information in two phases. At first, pixel values in a certain picture are (or “block”) are predicted fro example by motion compensation means (finding and indicating an area in one of the previously coded video frames that corresponds closely to the block being coded) or by spatial means (using the pixel values around the block to be coded in a specified manner). Secondly, the prediction error, i.e. the difference between the predicted block of pixels and the original block of pixels, is coded. This may be done by transforming the difference in pixel values using a specified transform (e.g. Discrete Cosine Transform (DCT) or a variant of it), quantizing the coefficients and entropy coding the quantized coefficients. By varying the fidelity of the quantization process, encoder can control the balance between the accuracy of the pixel representation (picture quality) and size of the resulting coded video representation (file size or transmission bitrate). The encoding process is illustrated in FIG. 4. FIG. 4 illustrates an example of a video encoder, where Iₙ: Image to be encoded; P′ₙ: Predicted representation of an image block; Dₙ: Prediction error signal; D′ₙ: Reconstructed prediction error signal; I′ₙ: Preliminary reconstructed image; R′ₙ: Final reconstructed image; T, T⁻¹: Transform and inverse transform; Q, Q⁻¹: Quantization and inverse quantization; E: Entropy encoding; RFM: Reference frame memory; Pᵢₙₜₑᵣ: inter: Inter prediction; Pᵢₙₜᵣₐ: Intra prediction; MS: Mode selection; F: Filtering.

In some video codecs, such as HEVC, video pictures are divided into coding units (CU) covering the area of the picture. A CU consists of one or more prediction units (PU) defining the prediction process for the samples within the CU and one or more transform units (TU) defining the prediction error coding process for the samples in said CU. A CU may consist of a square block of samples with a size selectable from a predefined set of possible CU sizes. A CU with the maximum allowed size may be named as CTU (coding tree unit) and the video picture is divided into non-overlapping CTUs. A CTU can be further split into a combination of smaller CUs, e.g. by recursively splitting the CTU and resultant CUs. Each resulting CU may have at least one PU and at least one TU associated with it. Each PU and TU can be further split into smaller PUs and TUs in order to increase granularity of the prediction and prediction error coding processes, respectively. Each PU has prediction information associated with it defining what kind of a prediction is to be applied for the pixels within that PU (e.g. motion vector information for inter-predicted Pus and intra prediction directionality information for intra predicted PUs). Similarly, each TU is associated with information describing the prediction rerror decoding process for the samples within the said TU (including e.g. DCT coefficient information). It may be signaled at CU level whether prediction error coding is applied or not for each CU. In the case there is no prediction errors residual associated with the CU, it can be considered there are no TUs for said CU. The division of the image into CUs, and division of CUs into PUs and TUs may be signaled in the bitstream allowing the decoder to reproduce the intended structure of these units.

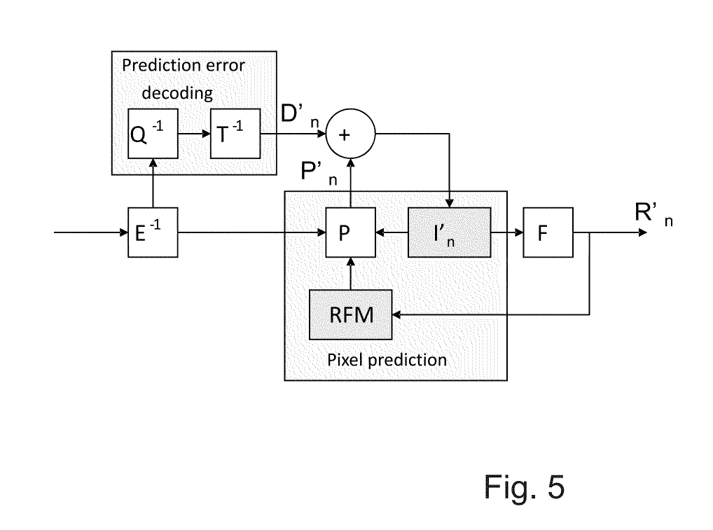

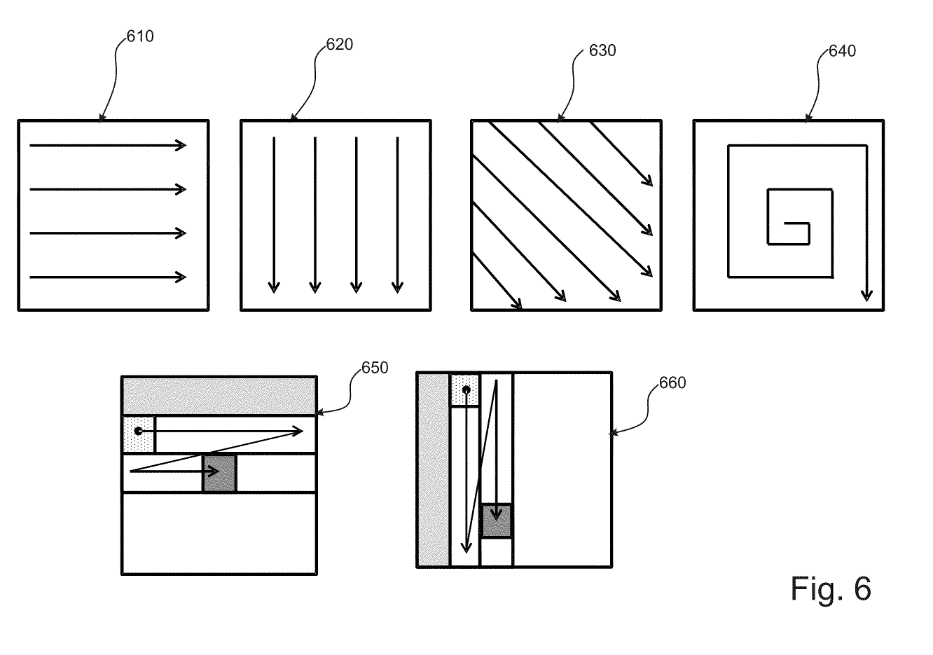

The decoded reconstructs the output video by applying prediction means similar to the encoder to form a predicted representation of the pixel blocks (using the motion or spatial information created by the encoder and stored in the compressed representation) and prediction error decoding (inverse operation of the prediction error coding recovering the quantized prediction error signal in spatial pixel domain). After applying prediction and prediction error decoding means, the decoder sums up the prediction and prediction error signals (pixel values) to form the output video frame. The decoder (and encoder) can also apply additional filtering means to improve the quality of the output video before passing it for display and/or storing it as prediction reference for the forthcoming frames in the video sequence. The decoding process is illustrated in FIG. 5. FIG. 5 illustrates a block diagram of a video decoder where P′ₙ: Predicted representation of an image block; D′ₙ: Reconstructed prediction error signal; I′ₙ: Preliminary reconstructed image; R′ₙ: Final reconstructed image; T⁻¹: Inverse transform; Q⁻¹: Inverse quantization; E⁻¹: Entropy decoding; RFM: Reference frame memory; P: Prediction (either inter or intra); F: Filtering.

Instead, or in addition to approaches utilizing sample value prediction and transform coding for indicating the coded sample values, a color palette based coding can be used. Palette based coding refers to a family of approaches for which a palette, i.e. a set of colors and associated indexes, is defined and the value for each sample within a coding unit is expressed by indicating its index in the palette. Palette based coding can achieve good coding efficiency in coding units with a small number of colors (such as image areas which are representing computer screen content, like text or simple graphics). In order to improve the coding efficiency of palette coding different kinds of palette index prediction approaches can be utilized, or the palette indexes can be run-length coded to be able to represent larger homogenous image areas efficiently.

A Decoded Picture Buffer (DPB) may be used in the encoder and/or in the decoder. There are two reasons to buffer decoded pictures, for references in inter prediction and for reordering decoded pictures into output order. As H.264/AVC and HEVC provide a great deal of flexibility for both reference picture marking and output reordering, separate buffers for reference picture buffering and output picture buffering may waste memory resources. Hence, the DPB may include a unified decoded picture buffering process for reference pictures and output reordering. A decoded picture may be removed from the DPB when it is no longer used as a reference and is not needed for output.

The motion information may be indicated in video codecs with motion vectors associated with each motion compensated image block. Each of these motion vectors represents the displacement of the image block in the picture to be coded (in the encoder side) or decoded (in the decoder side) and the prediction source block in one of the previously coded or decoded pictures. In order to represent motion vectors efficiently, those vectors may be coded differentially with respect to block specific predicted motion vectors. In video codecs, the predicted motion vectors may be created in a predefined way, e.g. by calculating the median of the encoded or decoded motion vectors or the adjacent blocks. Another way to create motion vector predictions is to generate a list of candidate predictions from adjacent blocks and/or co-located blocks in temporal reference pictures and signalling the chose candidate as the motion vector prediction. In addition to predicting the motion vector values, the reference index of previously coded/decoded picture can be predicted. The reference index is typically predicted from adjacent blocks and/or co-located blocks in temporal reference picture. Moreover, high efficiency video codecs may employ an addition motion information coding/decoding mechanism, called “merging/merge mode”, where all the motion field information, which includes motion vector and corresponding reference picture index for each available reference picture list, is predicted and used without any modification/correction. Similarly, predicting the motion field information is carried out using the motion field information or adjacent blocks and/or co-located blocks in temporal reference pictures and the user motion field information is signaled among a list of motion field candidate list filled with motion field information of available adjacent/co-located blocks.

In addition to applying motion compensation for inter picture prediction, similar approach can be applied to intra picture prediction. In this case the displacement vector indicates where from the same picture a block of samples can be copied to form a prediction of the block to be coded or decoded. This kind of intra block copying methods can improve the coding efficiency substantially in presence of repeating structures within the frame—such as text or other graphics.

In video codecs, the prediction residual after motion compensation may be first transformed with a transform kernel (e.g. DCT) and then coded. The reason for this is that there may still exit some correlation among the residual and transform can in many cases help reduce this correlation and provide more efficient coding.

Video encoders may utilize Lagrangian cost functions to find optimal coding modes, e.g. the desired macroblock mode and associated motion vectors. This kind of cost function uses a weighting factor λ to tie together the (exact or estimated) image distortion due to lossy coding methods and the (exact or estimated) amount of information that is required to represent the pixel values in an image area:

C=D+λR

Where C is the Lagrangian cost to be minimized, D is the image distortion (e.g. Mean Squared Error) with the mode and motion vectors considered, and R the number of bits needed to represent the required data to reconstruct the image block in the decoder (including the amount of data to represent the candidate motion vectors).

Scalable video coding refers to coding structure where one bitstream can contain multiple representations of the content at different bitrates, resolutions or frame rates. In these cases the receiver can extract the desired representation depending on its characteristics (e.g. resolution that matches best the display device). Alternatively, a server or a network element can extract the portions of the bitstream to be transmitted to the receiver depending on e.g. the network characteristics or processing capabilities of the receiver. A scalable bitstream may consist of a “base layer” providing the lowest quality video available and one or more enhancement layers that enhance the video quality when received and decoded together with the lower layers. In order to improve coding efficiency for the enhancement layers, the coded representation of that layer may depend on the lower layers. E.g. the motion and mode information of the enhancement layer can be predicted from lower layers. Similarly the pixel data of the lower layers can be used to create prediction for the enhancement layer.

A scalable video codec for quality scalability (also known as Signal-to-Noise or SNR) and/or spatial scalability may be implemented as follows. For a base layer, a conventional non-scalable video encoder and decoder are used. The reconstructed/decoded pictures of the base layer are included in the reference picture buffer for an enhancement layer. In H.264/AVC, HEVC, and similar codecs using reference picture list(s) for inter prediction, the base layer decoded pictures may be inserted into a reference picture list(s) for coding/decoding of an enhancement layer picture similarly to the decoded reference pictures of the enhancement layer. Consequently, the encoder may choose a base-layer reference picture as inter prediction reference and indicate its use with a reference picture index in the coded bitstream. The decoder decodes from the bitstream, for example from a reference picture index, that a base-layer picture is used as inter prediction reference for the enhancement layer. When a decoded base-layer picture is used as prediction reference for an enhancement layer, it is referred to as an inter-layer reference picture.

In addition to quality scalability, there are also other scalability modes: spatial scalability, bit-depth scalability and chroma format scalability. In spatial scalability base layer pictures are coded at a higher resolution than enhancement layer pictures. In Bit-depth scalability base layer pictures are coded at lower bit-depth (e.g. 8 bits) than enhancement layer pictures (e.g. 10 or 12 bits). In chroma format scalability base layer pictures provide higher fidelity in chroma (e.g. coded in 4:4:4 chroma format) than enhancement layer pictures (e.g. 4:2:0 format).

In the above scalability cases, base layer information can be used to code enhancement layer to minimize the additional bitrate overhead.

Scalability can be enabled in two ways. Either by introducing new coding modes for performing prediction of pixel values or syntax from lower layers of the scalable representation or by placing the lower layer pictures to the reference picture buffer (decoded picture buffer, DPB) of the higher layer. The first approach is more flexible and thus can provide better coding efficiency in most cases. However, the second, reference frame based scalability, approach can be implemented very efficiently with minimal changes to single layer codecs while still achieving majority of the coding efficiency gains available. Essentially a reference frame based scalability codec can be implemented by utilizing the same hardware or software implementation for all the layers, just taking care of the DPB management by external means.

When a CU is coded in palette mode, the correlation between pixels within the CU is exploited using various prediction strategies. For example, mode information can be signalled for each row of pixels that indicates one of the following: the mode can be horizontal mode where it means that a single palette index is signaled and the whole pixel line shares this index; the mode can be vertical mode, where the whole pixel line is the same with the above line, and no further information is signaled; the mode can be normal mode, where in this case a flag is signalled for each pixel position to indicate whether it is the same with one of the left and other pixels—and if not, the color index itself is separately transmitted.

In the following some examples will be provided. In the examples a statistical correlations between pixels within palette coded CUs are exploited. This is done by using different scan orders in addition to horizontal raster scan. More specifically, in the examples a set of predefined scan orders for palette coded pixels are defined and it is signaled which one to use at CU level.

According to an embodiment, a coding unit (CU) compressed in palette mode is decoded so that for a palette coded CU, an indication about the scan order of the palette mode is decoded. Further, for one or more pixels within the CU, a mode information is decoded. If the decoded mode indicates that the current pixel of a group of pixels subsequent to the current pixel within the indicated scan order is copied from a neighboring pixel or pixels, the prediction pixels using the scan order of the palette mode is determined. If the decoded mode indicates that a number of pixels share the same value, further an indication to determine the number of pixels sharing the same value and an indication for the reconstruction value of the pixels are decoded. Using the scan order of the palette mode and the number of pixels being determined, the corresponding group of pixels is determined, and their value is set to the reconstructed pixel value. (FIG. 6: 650 for the horizontal scan and 660 for the vertical scan) The process continues with moving to the next pixel that is to be reconstructed according the scan order and the decoded mode of the pixel of group of pixels.

In this embodiment, the scan order may indicate a horizontal (FIG. 6: 610) or a vertical scan (FIG. 6: 620).

If horizontal scan (610) is indicated for the palette coded CU, then scan order for the palette CU is set as horizontal raster scan. The process is started from the top-left pixel and the mode information is decoded. For each signaled mode, the following operations are performed: In the mode of copy from above, no further indication is signaled and the reconstruction of the pixel is set as the reconstruction value of the pixel directly above the current pixel; In the run-length mode, a pixel value and an associated run value is signaled (or run value can be inferred by other means) and all pixels following the current pixel in the horizontal raster scan shares the same pixel value; In escape mode, the value of the current pixel is explicitly signaled.

If vertical scan (620) is indicated, the scan order for the palette CU is set as vertical raster scan. The process is started from the top-left pixel and the mode indication is decoded. For each signaled mode, the following operations are performed: In the mode of copy from left, no further indication is signaled and the reconstruction of the pixel is set as the reconstruction value of the pixel of the pixel directly left of the current pixel; In the run-length mode, a pixel value and an associated run value is signaled (or run value can be inferred by other means) and all pixels following the current pixel in the vertical raster scan shares the same pixel value; In the escape mode, the value of the current pixel is explicitly signaled.

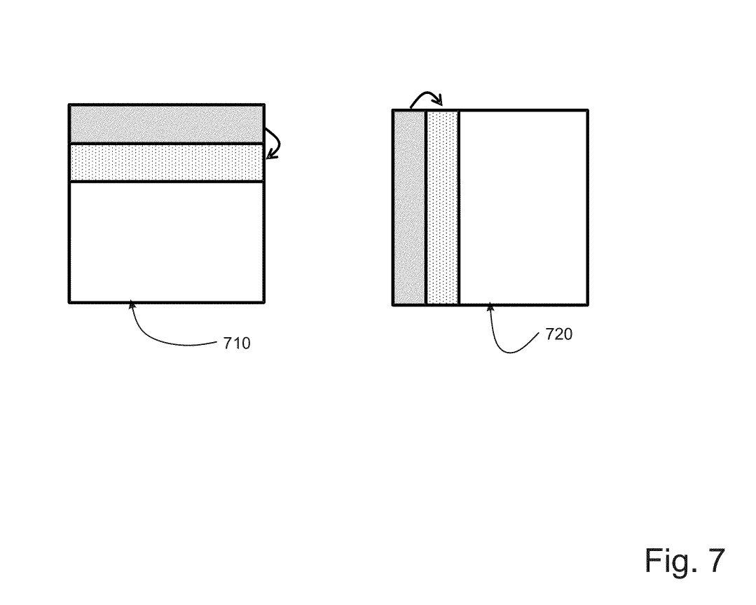

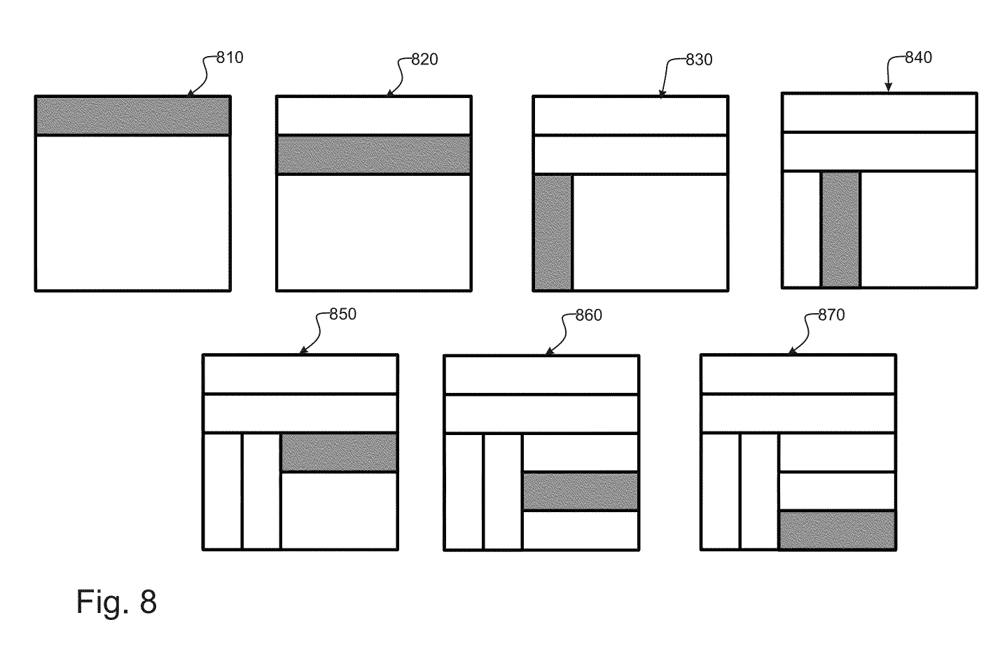

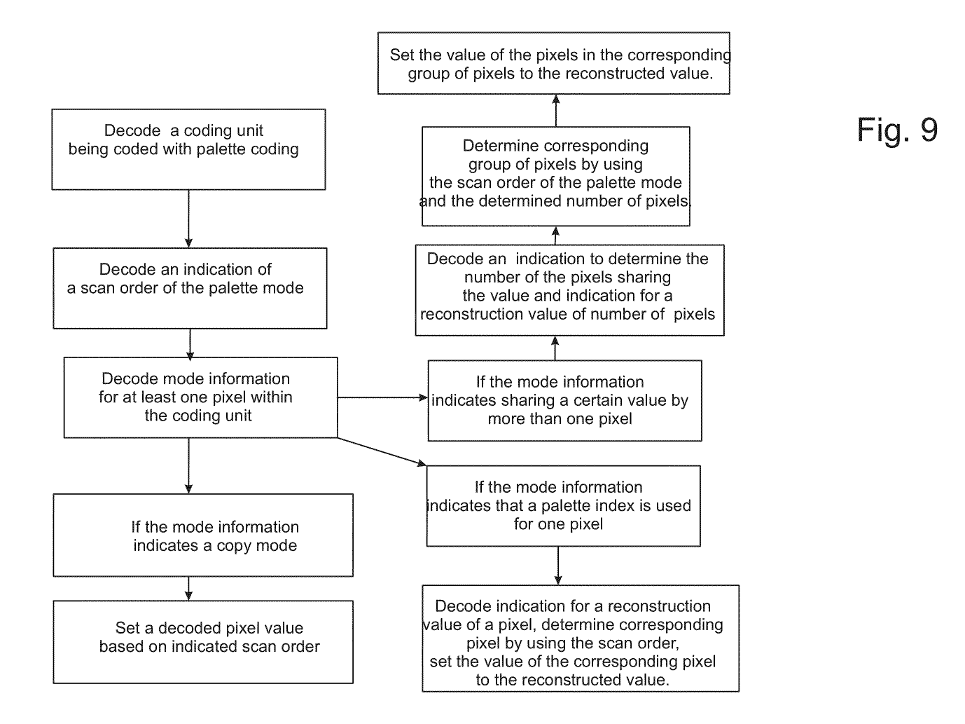

According to an embodiment, additional scan types can be used. For example the following scan types can be utilized in addition (or as an replacement) to horizontal and vertical scan types: horizontal—right to left; vertical—bottom to top; diagonal (630), spiral scan starting from the center of the block (640). Examples of different scan types are illustrated in FIG. 6. The scan types can also change within a CU (FIG. 8 indicates alternative scans). In this case, the scan types can be signaled at a sub-CU level, e.g. at the start of each pixel line. The scan type indication can be coded predictively using the information from neighboring CUs. The prediction modes of the pixels can be different than the one indicated above. For example, a separate mode can be used to indicate the whole pixel line whether to copy from the whole pixel line from above to left. In this case, the prediction pixels and the current group of pixels depend on the scan order of the CU. For example, if vertical scan is used and the prediction mode is copy from left, then the current group of pixels refer to column of pixels and the prediction pixels refer to the column or pixels directly to the left of the current column of pixels (see FIG. 7)

According to an embodiment, additional scan types can be indicated at various levels. For example, for each coding unit the scan type can be signaled to indicate the scan type of said coding unit. Alternatively, the scan type can be indicated at slice header and all the coding units within the slice use the same scan type. As a further alternative, multiple scan types can be indicated at slice header and for each coding unit a further indication is signaled to indicate which one of the scan types signaled at slice header is used for the said coding unit.

The present embodiments provide advantages over approaches utilizing fixed scanning of coding units. For example, by means of the method, the coding efficiency of the palette based image/video coding is improved without significant effect on encoding or decoding complexity.

The various embodiments of the invention can be implemented with the help of computer program code that resides in a memory and causes the relevant apparatuses to carry out the invention. For example, a device may comprise circuitry and electronics for handling, receiving and transmitting data, computer program code in a memory, and a processor that, when running the computer program code, causes the device to carry out the features of an embodiment. Yet further, a network device like a server may comprise circuitry and electronics for handling, receiving and transmitting data, computer program code in a memory, and a processor that, when running the computer program code, causes the network device to carry out the features of an embodiment.

If desired, the different functions discussed herein may be performed in a different order and/or concurrently with each other. Furthermore, if desired, one or more of the above-described functions may be optional or may be combined.

Although various aspects of the invention are set out in the independent claims, other aspects of the invention comprise other combinations of features from the described embodiments and/or the dependent claims with the features of the independent claims, and not solely the combinations explicitly set out in the claims.

It is also noted herein that while the above describes example embodiments of the invention, these descriptions should not be viewed in a limiting sense. Rather, there are several variations and modifications which may be made without departing from the scope of the present invention as defined in the appended claims

According to a first example, there is provided a method comprising:

decoding a coding unit being coded with palette coding, comprising
a. decoding an indication of a scan order of the palette mode;
b. decoding mode information for at least one pixel within the coding unit, and
   i. if said mode information indicates a copy mode, a decoded pixel value is set based on indicated scan order; or
   ii. if said mode information indicates that more than one pixel shares a certain value, an indication to determine the number of the pixels sharing the value and indication for a reconstruction value of number of pixels are decoded; and corresponding group of pixels is determined by using the scan order of the palette mode and the determined number of pixels, and the values of the pixels in the corresponding group of pixels is set to the reconstructed value; or
   iii. if said mode information indicates that a palette index is used for one pixel, an indication for a reconstruction value of a pixel is decoded, and corresponding pixel is determined by using the scan order of the palette mode, and the value of the corresponding pixel is set to the reconstructed value.

According to an embodiment, the scan order indicates a horizontal scan from left to right, wherein
setting scan order for the coding unit as horizontal raster scan;
decoding mode indications for pixels starting from a top-left pixel;
if the mode indication is an above copy mode, setting the reconstruction of the pixel as the reconstruction value of the pixel directly above the current pixel;
if the mode indication is a run-length mode, signalling a pixel value and an associated run value;
if the mode indication is escape mode, signalling the value of the current pixel.

According to an embodiment, the scan order indicates a vertical scan from top to bottom, wherein
setting scan order for the coding unit as vertical raster scan;
decoding mode indications for pixels starting from a top-left pixel;
if the mode indication is left copy mode, setting the reconstruction of the pixel as the reconstruction value of the pixel directly left of the current pixel;
if the mode is run-length mode, signalling a pixel value and associated run value;
if the mode indication is escape mode, signalling the value of the current pixel.

According to an embodiment, decoding an indication for the scan order for said coding unit

According to an embodiment, decoding an indication for the scan order for slice header.

According to an embodiment, the scan order indicates one of the following scan types:

horizontal from right to left, vertical from bottom to up, diagonal or spiral from the center of the block.

According to an embodiment, the scan order indicates more than one scan type within a coding unit, wherein the method comprises signaling scan types at a sub-coding unit level.

According to an embodiment the method comprises coding the scan type indication predictively using information from neighboring coding units.

According to a second example, there is provided an apparatus comprising at least one processor; and at least one memory including computer program code the at least one memory and the computer program code configured to, with the at least one processor, cause the apparatus to perform at least the following: decoding a coding unit being coded with palette coding, comprising
a. decoding an indication of a scan order of the palette mode;
b. decoding mode information for at least one pixel within the coding unit, and
   i. if said mode information indicates a copy mode, a decoded pixel value is set based on indicated scan order; or
   ii. if said mode information indicates that more than one pixel shares a certain value, an indication to determine the number of the pixels sharing the value and indication for a reconstruction value of number of pixels are decoded; and corresponding group of pixels is determined by using the scan order of the palette mode and the determined number of pixels, and the values of the pixels in the corresponding group of pixels is set to the reconstructed value; or
   iii. if said mode information indicates that a palette index is used for one pixel, an indication for a reconstruction value of a pixel is decoded, and corresponding pixel is determined by using the scan order of the palette mode, and the value of the corresponding pixel is set to the reconstructed value.

According to a third example, there is provided an apparatus comprising
means for processing;
means for decoding an indication of a scan order of the palette mode;
means for decoding mode information for at least one pixel within the coding unit, and
means for determining
   i. if said mode information indicates a copy mode, wherein a decoded pixel value is set based on indicated scan order; or
   ii. if said mode information indicates that more than one pixel shares a certain value, wherein means for decoding is configured to decode an indication to determine the number of the pixels sharing the value and indication for a reconstruction value of number of pixels; and corresponding group of pixels is determined by using the scan order of the palette mode and the determined number of pixels, and the values of the pixels in the corresponding group of pixels is set to the reconstructed value; or
   iii. if said mode information indicates that a palette index is used for one pixel, wherein the means for decoding is configured to decode an indication for a reconstruction value of a pixel, and corresponding pixel is determined by using the scan order of the palette mode, and the value of the corresponding pixel is set to the reconstructed value.

According to a fourth example, there is provided a computer program product comprising a computer-readable medium bearing computer program code embodied therein for use with a computer, the computer program code comprising:
a. code for decoding an indication of a scan order of the palette mode;
b. code for decoding mode information for at least one pixel within the coding unit, and
   i. if said mode information indicates a copy mode, a decoded pixel value is set based in indicated scan order; or
   ii. if said mode information indicates that more than one pixel shares a certain value, an indication to determine the number of the pixels sharing the value and indication for a reconstruction value of number of pixels are decoded; and corresponding group of pixels is determined by using the scan order of the palette mode and the determined number of pixels, and the values of the pixels in the corresponding group of pixels is set to the reconstructed value; or
   iii. if said mode information indicates that a palette index is used for one pixel, an indication for a reconstruction value of a pixel is decoded, and corresponding pixel is determined by using the scan order of the palette mode, and the value of the corresponding pixel is set to the reconstructed value.

According to a fifth example, there is provided a non-transitory computer-readable medium encoded with instructions that, when executed by a computer, perform
a. decoding an indication of a scan order of the palette mode;
b. decoding mode information for at least one pixel within the coding unit, and
   i. if said mode information indicates a copy mode, a decoded pixel value is set based on indicated scan order; or
   ii. if said mode information indicates that more than one pixel shares a certain value, an indication to determine the number of the pixels sharing the value and indication for a reconstruction value of number of pixels are decoded; and corresponding group of pixels is determined by using the scan order of the palette mode and the determined number of pixels, and the values of the pixels in the corresponding group of pixels is set to the reconstructed value; or
   iii. if said mode information indicates that a palette index is used for one pixel, an indication for a reconstruction value of a pixel is decoded and corresponding pixel is determined by using the scan order of the palette mode, and the value of the corresponding pixel is set to the reconstructed value.

1. A method comprising:
decoding a coding unit being coded with palette coding, comprising
decoding an indication of a scan order of the palette mode;
decoding mode information for at least one pixel within the coding unit, and
if said mode information indicates a copy mode,
setting a decoded pixel value based on indicated scan order; or
if said mode information indicates that more than one pixel shares a certain value,
decoding an indication to determine the number of the pixels sharing the value and indication for a reconstruction value of number of pixels; and
determining corresponding group of pixels by using the scan order of the palette mode and the determined number of pixels, and
setting the values of the pixels in the corresponding group of pixels to the reconstructed value; or
if said mode information indicates that a palette index is used for one pixel,
decoding an indication for a reconstruction value of a pixel, and
determining corresponding pixel by using the scan order of the palette mode, and
setting the value of the corresponding pixel to the reconstructed value.

2. The method according to claim 1, wherein the scan order indicates a horizontal scan from left to right, wherein the method comprises
setting the scan order for the coding unit as horizontal raster scan;
decoding mode indications for pixels starting from a top-left pixel;
if the mode indication is an above copy mode,
setting the reconstruction of the pixel as the reconstruction value of the pixel directly above the current pixel;
if the mode indication is a run-length mode,
signalling a pixel value and an associated run value;
if the mode indication is escape mode,
signalling the value of the current pixel.

3. The method according to claim 1, wherein the scan order indicates a vertical scan from top to bottom, wherein the method comprises
setting scan order for the coding unit as vertical raster scan;
decoding mode indications for pixels starting from a top-left pixel;
if the mode indication is left copy mode,
setting the reconstruction of the pixel as the reconstruction value of the pixel directly left of the current pixel;
if the mode is run-length mode,
signalling a pixel value and associated run value;
if the mode indication is escape mode,
signalling the value of the current pixel.

4. The method according to claim 1, further comprising decoding an indication for the scan order for said coding unit.

5. The method according to claim 1, further comprising decoding an indication for the scan order for slice header.

6. The method according to claim 1, wherein the scan order indicates one of the following scan types: horizontal from right to left, vertical from bottom to up, diagonal or spiral from the center of the block.

7. The method according to claim 1, wherein the scan order indicates more than one scan type within a coding unit, wherein the method comprises signaling scan types at a sub-coding unit level.

8. The method according to claim 1, further comprising coding the scan type indication predictively using information from neighboring coding units.

9. An apparatus comprising at least one processor; and at least one memory including computer program code the at least one memory and the computer program code configured to, with the at least one processor, cause the apparatus to perform at least the following:
decode a coding unit being coded with palette coding, comprising
decode an indication of a scan order of the palette mode;
decode mode information for at least one pixel within the coding unit, and
if said mode information indicates a copy mode,
set a decoded pixel value based on indicated scan order; or
if said mode information indicates that more than one pixel shares a certain value,
decode an indication to determine the number of the pixels sharing the value and indication for a reconstruction value of number of pixels; and
determine a corresponding group of pixels by using the scan order of the palette mode and the determined number of pixels, and
set the values of the pixels in the corresponding group of pixels to the reconstructed value; or
if said mode information indicates that a palette index is used for one pixel,
decode an indication for a reconstruction value of a pixel, and
determine corresponding pixel by using the scan order of the palette mode, and
set the value of the corresponding pixel to the reconstructed value.

10. The apparatus according to claim 9, wherein the scan order indicates a horizontal scan from left to right, wherein the apparatus further comprising computer program code to cause the apparatus to
set the scan order for the coding unit as horizontal raster scan;
decode mode indications for pixels starting from a top-left pixel;
if the mode indication is an above copy mode,
to set the reconstruction of the pixel as the reconstruction value of the pixel directly above the current pixel;
if the mode indication is a run-length mode,
to signal a pixel value and an associated run value;
if the mode indication is escape mode,
to signal the value of the current pixel.

11. The apparatus according to claim 9, wherein the scan order indicates a vertical scan from top to bottom, wherein the apparatus further comprising computer program code to cause the apparatus to
set scan order for the coding unit as vertical raster scan;
decode mode indications for pixels starting from a top-left pixel;
if the mode indication is left copy mode,
to set the reconstruction of the pixel as the reconstruction value of the pixel directly left of the current pixel;
if the mode is run-length mode,
to signal a pixel value and associated run value;
if the mode indication is escape mode,
to signal the value of the current pixel.

12. The apparatus according to claim 9, further comprising computer program code to cause the apparatus to decode an indication for the scan order for said coding unit.

13. The apparatus according to claim 9, further comprising computer program code to cause the apparatus to decode an indication for the scan order for slice header.

14. The apparatus according to claim 9, wherein the scan order indicates one of the following scan types: horizontal from right to left, vertical from bottom to up, diagonal or spiral from the center of the block.

15. The apparatus according to claim 9, wherein the scan order indicates more than one scan type within a coding unit, wherein the method comprises signaling scan types at a sub-coding unit level.

16. The apparatus according to claim 9, further comprising computer program code to cause the apparatus to code the scan type indication predictively using information from neighboring coding units.

17. A non-transitory computer-readable medium encoded with instructions that, when executed by a computer, perform
decoding a coding unit being coded with palette coding, comprising
decoding an indication of a scan order of the palette mode;
decoding mode information for at least one pixel within the coding unit, and
if said mode information indicates a copy mode,
setting a decoded pixel value based on indicated scan order; or
if said mode information indicates that more than one pixel shares a certain value,
decoding an indication to determine the number of the pixels sharing the value and indication for a reconstruction value of number of pixels; and
determining a corresponding group of pixels by using the scan order of the palette mode and the determined number of pixels, and
setting the values of the pixels in the corresponding group of pixels to the reconstructed value; or
if said mode information indicates that a palette index is used for one pixel,
decoding an indication for a reconstruction value of a pixel and
determining a corresponding pixel by using the scan order of the palette mode, and
setting the value of the corresponding pixel to the reconstructed value.
